(19) United States
(12) Patent Application Publication
(10) Pub. No.: US 2010/0255374 A1
(43) Pub. Date: Oct. 7, 2010

(54) NONAQUEOUS ELECTROLYTE SECONDARY BATTERY

(75) Inventors: Akiyoshi Nemoto, Tsukuba-shi (JP); Kazuyuki Tanino, Tsukuba-shi (JP); Kenji Nakane, Tsukuba-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Chuo-ku, Tokyo (JP)

(21) Appl. No.: 12/745,856

(22) PCT Filed: Dec. 4, 2008
(86) PCT No.: PCT/JP2008/072462

§ 371 Date: Jun. 2, 2010

(30) Foreign Application Priority Data
Dec. 6, 2007 (JP) 2007-315581

(51) Int. Cl. H01M 4/525

(52) U.S. Cl. 429/221

(57) ABSTRACT

A nonaqueous electrolyte secondary battery comprising
a positive electrode containing a granular positive electrode active material composed of a mixed metal oxide and an M³-containing compound (M³ represents one or more elements selected from the group consisting of Group 3B elements in the periodic table, and the M³-containing compound is different from said mixed metal oxide) placed in the form of particles or a layer on the surface of the mixed metal oxide, wherein the positive electrode active material has M¹ (M¹ represents one or more elements selected from the group consisting of alkali metal elements), M² (M² represents one or more elements selected from the group consisting of Mn, Fe, Co and Ni), M³ (M³ has the same meaning as that described above) and O on its surface, and when the molar ratio (M³/M²) of the number of M³ atoms (mol) to the number of M² atoms (mol) on the surface of the positive electrode active material is represented by A and the BET specific surface area of the positive electrode active material is represented by S (m²/g), A and S satisfy the following formula (1):

A/S≧1 (1),
a negative electrode, a separator, and a nonaqueous electrolyte.

### TECHNICAL FIELD

The present invention relates to a nonaqueous electrolyte secondary battery.

### BACKGROUND ART

A nonaqueous electrolyte secondary battery typified by a lithium secondary battery is tried to be applied, as an power supply in various applications, such as a small size power supply for a mobile instrument, e.g., a cell phone and a laptop computer, and electric tools, and a large size power supply, e.g., an electric automobile, and a hybrid automobile, or a distributed power supply, and its demand is increasing more and more.

On the other hand, because the nonaqueous electrolyte secondary battery is composed of a positive electrode, a negative electrode, a separator and a nonaqueous electrolyte as main components and has a higher energy density as compared with a secondary battery containing an aqueous electrolyte as an electrolyte, higher safety is required for the nonaqueous electrolyte secondary battery.

Therefore, it is investigated to develop a positive electrode active material capable of providing a nonaqueous electrolyte secondary battery having higher safety (see, e.g., JP-A No. 2007-258139).

### DISCLOSURE OF THE INVENTION

The present invention has an object of providing a nonaqueous electrolyte secondary battery having higher safety, especially, a nonaqueous electrolyte secondary battery showing a higher safety also in the case of keeping at a high temperature.

In view of the above-described situations, the present inventors performed experiments and investigations repeatedly on materials constituting the above-described components of a nonaqueous electrolyte secondary battery, such as a positive electrode active material contained in a positive electrode, and a combination of these components, and resultantly have found that the following inventions correspond the above-described object, leading to completion of the present invention.

The present invention provides the following inventions.

<1> A nonaqueous electrolyte secondary battery comprising

a positive electrode containing a granular positive electrode active material composed of a mixed metal oxide and an M³-containing compound (M³ represents one or more elements selected from the group consisting of Group 3B elements in the periodic table, and the M³-containing compound is different from said mixed metal oxide) placed in the form of particles or a layer on the surface of the mixed metal oxide, wherein the positive electrode active material has M¹ (M¹ represents one or more elements selected from the group consisting of alkali metal elements), M² (M² represents one or more elements selected from the group consisting of Mn, Fe, Co and Ni), M³ (M³ has the same meaning as that described above) and O on its surface, and when the molar ratio (M³/M²) of the number of M³ atoms (mol) to the number of M² atoms (mol) on the surface of the positive electrode active material is represented by A and the BET specific surface area of the positive electrode active material is represented by S (m²/g), A and S satisfy the following formula (I):

A/S≧1 (1),

a negative electrode,

a separator, and

a nonaqueous electrolyte.

<2> The nonaqueous electrolyte secondary battery according to <1>, wherein the separator is composed of a laminated film in which a heat resistant porous layer and a porous film are laminated.

<3> The nonaqueous electrolyte secondary battery according to <1> or <2>, wherein the nonaqueous electrolyte contains a carbonate and a fluorine compound.

<4> The nonaqueous electrolyte secondary battery according to any one of <1> to <3>, wherein the negative electrode contains a carbonaceous material as a negative electrode active material.

<5> The nonaqueous electrolyte secondary battery according to any one of <1> to <4>, wherein said A is 0.35 or more.

<6> The nonaqueous electrolyte secondary battery according to any one of <1> to <5>, wherein said S is 0.1 or more and 3 or less.

<7> The nonaqueous electrolyte secondary battery according to any one of <1> to <6>, wherein said M¹ represents Li.

<8> The nonaqueous electrolyte secondary battery according to any one of <1> to <7>, wherein said M³ represents Al.

<9> The nonaqueous electrolyte secondary battery according to any one of <1> to <8>, wherein said M² represents Ni and Co.

### BEST MODES FOR CARRYING OUT THE INVENTION

The nonaqueous electrolyte secondary battery of the present invention comprises a positive electrode containing a granular positive electrode active material composed of a mixed metal oxide and an M³-containing compound (M³ represents one or more elements selected from the group consisting of Group 3B elements in the periodic table, and the M³-containing compound is different from said mixed metal oxide) placed in the form of particles or a layer on the surface of the mixed metal oxide, wherein the positive electrode active material has M¹ (M¹ represents one or more elements selected from the group consisting of alkali metal elements), M² (M² represents one or more elements selected from the group consisting of Mn, Fe, Co and Ni), M³ (M³ has the same meaning as that described above) and O on its surface, and when the molar ratio (M³/M²) of the number of M³ atoms (mol) to the number of M² atoms (mol) on the surface of the positive electrode active material is represented by A and the BET specific surface area of the positive electrode active material is represented by S (m²/g), A and S satisfy the following formula (I):

A/S≧1 (1),

a negative electrode, a separator, and a nonaqueous electrolyte.

In the nonaqueous electrolyte secondary battery of the present invention, the positive electrode contains a granular positive electrode active material. The positive electrode active material is a granular positive electrode active material composed of a mixed metal oxide (hereinafter, referred to as “core material” in some cases) and an M³-containing compound (M³ represents one or more elements selected from the group consisting of Group 3B elements in the periodic table, and the M³-containing compound is different from the above-described mixed metal oxide) placed in the form of particles or a layer on the surface of the mixed metal oxide. In the present invention, also the core material is granular.

The above-described core material contains a transition metal element, and usually contains M¹. Therefore, the above-described core material can be doped and dedoped with ions of M¹.

Though the above-described transition metal element is not particularly restricted, it is preferably the above-described M².

The above-described M¹ represents one or more elements selected from the group consisting of alkali metal elements, and for enhancing a capacity of the secondary battery for the present invention, M¹ represents preferably Li and/or Na, more preferably Li.

In the present invention, when M¹ represents Li, the core material includes a mixed metal oxide containing L¹ and M² (M² represents one or more elements selected from the group consisting of Mn, Fe, Co and Ni), and also includes a mixed metal oxide in which a part of this M² is substituted by a heterogeneous element (for example, Ti, V, B, Al, and Ga) other than M². The core material is preferably a mixed metal oxide containing Li and Ni, that is, a mixed metal oxide containing at least Ni as the above-described M². The mixed metal oxide containing Li and Ni includes, specifically, a mixed metal oxide represented by the following formula (C1) and the following formula (C2).

LiₓNi_{1-y}M^{2 A}_{y}O₂ (C1)

wherein, the range of x and the range of y are 0.9≦x≦1.2 and 0≦y≦0.3, respectively, and M^{2 A} represents one or more elements selected from the group consisting of Co, Fe and Mn.

In the present invention, by using a mixed metal oxide of the formula (C1) as the mixed metal oxide, a nonaqueous electrolyte secondary battery which is suitable, particularly, for applications requiring high capacity such as a cell phone and a laptop computer can be produced. In the formula (C1), the range of y is preferably 0.01≦y≦0.2, more preferably 0.02≦y≦0.18.

LiₓNi_{1-z}M^{2 B}_{z}O (C2)

wherein, the range of x and the range of z are 0.9≦x≦1.2 and 0.3≦z≦0.9, respectively, and M^{2 B} represents one or more elements selected from the group consisting of Co, Fe and Mn.

In the present invention, by using a mixed metal oxide of the formula (C2) as the mixed metal oxide, a nonaqueous electrolyte secondary battery which is suitable for applications requiring high power output such as an electric tool, an electric automobile, and a hybrid automobile can be produced. In the formula (C2), M^{2 B} preferably represents two or more elements selected from the group consisting of Co, Fe and Mn, and the range of z is preferably 0.4≦z≦0.8, more preferably 0.5≦z≦0.7.

In the above-described formula (C1) and formula (C2), the range of x is preferably 0.95≦x≦1.1 from the standpoint of cycle performance of the nonaqueous electrolyte secondary battery.

In the above-described mixed metal oxide containing L¹ and M², M² represents preferably Ni and Co for enhancing the capacity of the resultant nonaqueous electrolyte secondary battery, and in this case, M^{2 A} represents preferably Co in the formula (C1).

In the present invention, when M¹ represents Na, the core material includes a mixed metal oxide containing Na and M² (M² represents one or more elements selected from the group consisting of Mn, Fe, Co and Ni). Specifically mentioned are NaFeO₂, NaNiO₂, NaCoO₂, NaMnO₂, NaFe_{1-α}M^{2 1}_{α}O₂, NaNi_{1-α}M^{2 1}_{α}O₂, NaCO_{1-α}M^{2 1}_{α}O₂, and NaMn_{1-α}M^{2 1}_{α}O₂ (the above-described M^{2 1} represents one or more elements selected from the group consisting of trivalent metal elements, e.g., Al and Ga, and 0≦α<0.5).

In the present invention, the positive electrode active material has a M³-containing compound placed in the form of particles or a layer on the surface of the above-described core material. That is, the M³-containing compound adheres in the form of particles or a layer to the surface of the core material. This adhesion may be caused by chemical bonding between the M³-containing compound and the core material, or by physical adsorption. The M³-containing compound may adhere to a part of the surface of the core material particle. It is preferable that the M³-containing compound adhere to the whole surface of the core material particle and coat thereon. When the M³-containing compound adheres in the form of particles or a layer to the surface of the core material particle, the coating thickness is preferably 1 nm to 500 nm, more preferably 1 nm to 100 nm.

In the present invention, the positive electrode active material can be doped and dedoped with ions of M¹ even if the M³-containing compound is placed.

In the present invention, the M³-containing compound is different from the above-described mixed metal oxide. M³ represents one or more elements selected from the group consisting of Group 3B elements in the periodic table. That is, M³ includes elements such as Al, B, Ga, and In. For further enhancing the cycle performance of the resulting nonaqueous electrolyte secondary battery, M³ preferably represents Al. When M³ represents Al in the M³-containing compound, the Al-containing compound may be alumina, or a compound containing M¹ and Al. When M¹ represents Li, the compound containing Li and Al includes LiAlO₂ and the like. Compounds which cannot be doped and dedoped with lithium ions such as LiAlO₂ are preferable from the standpoint of further enhancing the cycle performance of the resulting lithium secondary battery.

In the present invention, the positive electrode active material has M¹ (M¹ has the same meaning as described above), M² (M² has the same meaning as described above), M³ (M³ has the same meaning as described above) and O on its surface, and when the molar ratio (M³/M²) of the number of M³ atoms (mol) to the number of M² atoms (mol) on the surface of the positive electrode active material is represented by A and the BET specific surface area of the positive electrode active material is represented by S (m²/g), A and S satisfy the following formula (I):

A/S≧1 (1).

In the present invention, that the positive electrode active material has M¹, M², M³ and O on its surface is measured by X-ray photoelectron spectroscopy. In the present invention, the surface of the positive electrode active material means a region specified by X-ray photoelectron spectroscopy under the following conditions.

Method: X-ray photoelectron spectroscopy (XPS)

X-ray: AlKα-ray (1486.6 eV)

X-ray spot diameter: 100 μm

Neutralization condition: neutralization electron gun (1 eV electron beam), low speed Ar ion gun (10 eV Ar ion beam)

For measurement, an X-ray source of AlKα-ray is used, and for charge neutralization, a neutralization electron gun, Ar ion gun and the like can be appropriately used. By irradiating the surface of the positive electrode active material with an X-ray, electron beam and Ar ion beam using these X-ray source, neutralization electron gun and Ar ion gun, respectively, a photoelectron on an element (atom) constituting the surface is confirmed, thereby understanding the presence of the element. The spectrum obtained by measurement can be subjected to waveform separation, if necessary, to determine the photoelectron intensity on each element. When the spectrum derived from a certain element (element 1) overlaps with the spectrum derived from another element, another spectrum derived from the element 1 may be appropriately selected.

By this X-ray photoelectron spectroscopy, that the positive electrode active material has M¹, M², M³ and O on its surface can be confirmed, and from the resultant spectrum, the photoelectron intensity on each element is determined, with performing waveform separation if necessary, and A representing the molar ratio (M³/M²) of the number of M³ atoms (mol) to the number of M² atoms (mol) on the surface of the positive electrode active material can be measured.

In the present invention, for enhancing the capacity, A is preferably 0.35 or more, more preferably 1.0 or more. The value of A is usually 100 or less. A can also have a value over 100, by means such as sputtering described later.

In the present invention, S representing the BET specific surface area of the positive electrode active material is measured by a BET one point method using a BET specific surface area measuring apparatus.

In the present invention, for enhancing capacity, S is usually 0.1 or more and 3 or less, more preferably 0.1 or more and 2 or less, further more preferably 0.1 or more and 1 or less.

In the present invention, A/S is 1 or more and usually about 50 or less, and if this is increased to a larger value such as 1000, the effect of the present invention can be further enhanced.

Next, a method of producing the positive electrode active material in the present invention is described.

First, the core material in the positive electrode active material can be produced by calcining a metal compound mixture which can become a core material after calcining. When the core material is a mixed metal oxide containing M¹ and M², the core material can be produced by weighing a raw material containing M¹ and a raw material containing M² to obtain a given composition, mixing them, calcining the resultant metal compound mixture, and if necessary, pulverizing the mixture. For example, a mixed metal oxide represented by Li_{1.11} [Ni_{0.36}Mn_{0.43}Co_{0.21}]O₂, which is one of preferable core material, can be obtained by weighing lithium hydroxide, nickel sesquioxide, manganese carbonate and cobalt oxide so that the molar ratio of Li:Ni:Mn:Co is 1.11:0.36:0.43:0.21, mixing them, and calcining the resultant metal compound mixture.

When M² represents several metal elements, for example, Ni and Co, a compound containing Ni and a compound containing Co may be used, or a compound containing Ni and Co may be used, as the material containing M². The compound containing Ni and Co is obtained by coprecipitation and the like. For further enhancing cycle performance in the nonaqueous electrolyte secondary battery, it is preferable to use a compound containing Ni and Co.

As the raw material containing M² and the raw material containing M², oxides, hydroxides, carbonates, nitrates, sulfates, halides and oxalates can be used.

The above-described mixing may be carried out by either a dry mixing or a wet mixing, and owing to simplicity, a dry mixing is preferable. In the dry mixing, a V-shaped mixer, a W-shaped mixer, a ribbon mixer, a drum mixer, a powder mixer having a stirring blade inside, a ball mill, a vibration mill, or a combination of these apparatuses, can be used. As the powder mixer having a stirring blade inside, a Loedige mixer (manufactured by MATSUBO Corporation) manufactured by MATSUBO Corporation is specifically mentioned. When mixing is insufficient, the capacity of the resultant nonaqueous electrolyte secondary battery lowers in some cases, it is preferable to perform pulverization mixing using a mixing apparatus equipped with a mixing medium such as a ball, and mixing efficiency can be improved thereby. As the mixing apparatus equipped with a mixing medium, a stirring type pulverizer (pulverizer having inside a stirring blade and a mixing medium) is specifically mentioned in addition to the above-described ball mill and vibration mill. The stirring type pulverizer includes, specially, Dynamic Mill (trade name) manufactured by Mitsui Mining Co., Ltd., Attritor, Fine Mill (trade name), Ultrafine Mill (trade name) manufactured by Mitsubishi Heavy Industries, Ltd., Micros (trade name) manufactured by Nara Machinery Co., Ltd., and the like. The above-described mixing apparatuses may have a screw instead of a stirring blade.

Calcination of the above-described metal compound mixture may be carried out while keeping at a temperature in the range of 600° C. or more and 1200° C. or less. The atmosphere for calcination is not particularly restricted, and air, oxygen, nitrogen, carbon dioxide, water vapor, nitrogen oxide, noble gas or a mixed gas of them may be used. Calcination may also be carried out under reduced pressure. For enhancing the capacity of the resultant nonaqueous electrolyte secondary battery, it is preferable to use an atmosphere containing oxygen. The time for keeping a temperature in the above-described range is usually about 0.5 hours to 24 hours. The calcined product obtained by the above-described calcination can be, if necessary, pulverized using a pulverizer such as a vibration mill, a jet mill, and a dry ball mill, and a core material can be obtained.

Using the core material obtained as described above, a positive electrode active material can be obtained by subjecting a M³-containing compound to placing on the surface of the core material, as described below. That is, a positive electrode active material can be obtained by subjecting a granular raw material containing M³ and the above-described core material to mixing and thermally treating. In this case, if the raw material containing M³ is the M³-containing compound, the thermal treatment is not necessary in some cases.

As the raw material containing M³, oxides, hydroxides, carbonates, nitrates, sulfates, halides and oxalates can be used, and oxides are preferable. In this case, when M³ represents, e.g., Al, it is preferable that the raw material containing M³ be alumina.

It is preferable that the raw material containing M³ be finer as compared with the particle of the core material, in order that the M³-containing compound may adhere to the surface of the core material more efficiently. Specifically, the BET specific surface area of the raw material containing M³ is preferably 5 times or more, more preferably 20 times or more with respect to the BET specific surface area of the core material. The use amount of the raw material containing M³ and the use amount of the core material may be adjusted so as to give a (core material):(the raw material containing M³) molar ratio of 1:0.03 to 0.15. The use amount of these is one of important factors exerting an influence on A/S in the present invention.

Mixing of the raw material containing M³ and the above-described core material may be carried out in the same manner as for mixing in the above-described core material production. In this case, under mixing with strong pulverization, the resultant positive electrode active material does not satisfy A/S in the present invention in some cases. Therefore, it is preferable to use no mixing apparatus equipped with a mixing medium such as a ball. Namely, it is preferable to carry out mixing using a mixing apparatus with no strong pulverization, such as mixing using a powder mixer having a stirring blade inside. In the case of performing mixing using a mixing apparatus having a mixing medium, it is preferable to use a medium having a soft surface such as a nylon-coated steel sphere as the medium.

Thermal treatment condition (temperature, keeping time) in the thermal treatment to be carried out after mixing is one of important factors which exert an influence on A/S. Though the thermal treatment temperature varies in some cases depending on the kind of the raw material containing M³ to be used, the thermal treatment temperature may be approximately the same as the temperature kept in calcination carried out in the above-described core material production. For example, it is preferable that the thermal treatment temperature be set at a level of (the calcination keeping temperature in core material production)−30° C. or more and (the calcination keeping temperature in core material production)+30° C. or less. It is preferable to set the keeping time in the thermal treatment shorter than the keeping time in calcination. As the atmosphere in the thermal treatment, the same atmosphere as in the above-described calcination may be used.

When the raw material containing M³ is not granular, the positive electrode active material in the present invention can be obtained by subjecting an element M-containing compound to placing in the form of a layer on the surface of the particle of the core material, by the use of a method such as sputtering.

The positive electrode containing the positive electrode active material can be produced as described below. The positive electrode is usually in the form of a sheet, and can be produced by allowing a positive electrode mixture containing the positive electrode active material, electric conductive material and binder to be supported on a positive electrode current collector in the form of a sheet.

As the above-described electrical conductive material, carbonaceous materials can be used, and the carbonaceous materials include a graphite powder, carbon black, acetylene black, filamentous carbonaceous material and the like. Carbon black and acetylene black can be added in small amount into a positive electrode mixture to enhance the electric conductivity of a positive electrode and to improve charge and discharge efficiency and rate property since carbon black and acetylene black are in the form of fine particles and have a large surface area, however, when added in too large amount, an adhesion property by a binder between a positive electrode mixture and a positive electrode current collector is lowered, possibly leading to a cause for decrease in electric conductivity of a positive electrode, by contrast. Usually, the proportion of an electrical conductive material in a positive electrode mixture is 5 parts by weight or more and 20 parts by weight or less with respect to 100 parts by weight of the positive electrode active material. In the case of using a filamentous carbonaceous material such as graphitized carbon fiber, carbon nanotube and the like as the electrical conductive material, it is also possible to decrease this proportion.

As the binder in a positive electrode, thermoplastic resins can be used. Specifically mentioned are fluorine resins such as polyvinylidene fluoride (hereinafter, referred to as PVDF in some cases), polytetrafluoroethylene (hereinafter, referred to as PTFE in some cases), ethylene tetrafluoride/propylene hexafluoride/vinylidene fluoride copolymer, propylene hexafluoride/vinylidene fluoride copolymer, and ethylene tetrafluoride/perfluoro vinyl ether copolymer, and polyolefin resins such as polyethylene, and polypropylene, etc. Two or more of these compounds may be used in admixture. Further, a positive electrode mixture excellent in adhesion property with a positive electrode current collector can be obtained by using a fluorine resin and a polyolefin resin as the binder, and containing them so that the proportion of the fluorine resin with respect to the positive electrode mixture is 1 to 10% by weight and the proportion of the polyolefin resin with respect to the positive electrode mixture is 0.1 to 2% by weight.

As the above-described positive electrode current collector, Al, Ni, stainless steel and the like can be used. Al is preferable since it can be processed into a thin film easily and it is cheap. As the method for allowing a positive electrode mixture to be supported on a positive electrode current collector, there is mentioned a method of pressure molding or a method of pasting using an organic solvent and the like, and applying this on a positive electrode current collector and drying this, then, performing pressing and the like to attain fixation thereof. In the case of pasting, a slurry composed of a positive electrode active material, an electrical conductive material, a binder and an organic solvent is produced. The organic solvent includes amine solvents such as N,N-dimethylaminopropylamine, and diethylenetriamine, ether solvents such as tetrahydrofuran, ketone solvents such as methyl ethyl ketone, ester solvents such as methyl acetate, amide solvents such as dimethylacetamide, and N-methyl-2-pyrrolidone (NMP); etc.

Examples of the method of applying a positive electrode mixture on a positive electrode current collector include a slit die coating method, a screen coating method, curtain coating method, a knife coating method, a gravure coating method, and an electrostatic spray method. By the methods mentioned above, a positive electrode can be produced.

Next, the negative electrode is explained. In the present invention, the negative electrode contains a negative electrode active material, and can be doped and dedoped with ions of M¹ at a potential lower than that for a positive electrode. Mentioned as the negative electrode are electrodes in which a negative electrode mixture containing a negative electrode active material is supported on a negative electrode current collector, or electrodes composed of a negative electrode active material. The negative electrode active material includes carbonaceous materials, chalcogen compounds (oxides, sulfides and the like), nitrides, metals or alloys, which can be doped and dedoped with ions of M¹ at a potential lower than that for a positive electrode. These negative electrode active materials may also be used in admixture.

The above-described negative electrode active materials, particularly in which M¹ represents Li, is exemplified below. As the carbonaceous material which can be doped and dedoped with Li ions, specifically, preferable are carbonaceous materials such as graphite, e.g., natural graphite and artificial graphite, cokes, carbon black, pyrolytic carbons, carbon fiber, and organic polymer compound calcined bodies. As the carbonaceous material, carbonaceous materials composed mainly of graphite such as natural graphite and artificial graphite are preferable from the standpoint of high flatness of potential, low average discharge potential and the like. The shape of the carbonaceous material may be any of, for example, a flake like natural graphite, a sphere like meso carbon micro bead, a fiber like graphitized carbon fiber, an aggregate of fine powder, and the like. Specifically mentioned as the above-described oxide are oxides of silicon represented by the formula SiOₓ (wherein, x represents a positive real number) such as SiO₂, and SiO, oxides of titanium represented by the formula TiOₓ (wherein, x represents a positive real number) such as TiO₂, and TiO, oxides of vanadium represented by the formula VOₓ (wherein, x represents a positive real number) such as V₂O₅, and VO₂, oxides of iron represented by the formula FeOₓ (wherein, x represents a positive real number) such as Fe₃O₄, Fe₂O₃, and FeO, oxides of tin represented by the formula SnOₓ (wherein, x represents a positive real number) such as SnO₂, and SnO, oxides of tungsten represented by the formula WOₓ (wherein, x represents a positive real number) such as WO₃, and WO₂, mixed metal oxides containing lithium and titanium and/or vanadium such as Li₄Ti₅O₁₂, and LiVO₂ (e.g., Li_{1.1}V_{0.9}O₂); etc. Specifically mentioned as the above-described sulfide are sulfides of titanium represented by the formula TiSₓ (wherein, x represents a positive real number) such as Ti₂S₃, TiS₂, and TiS, sulfides of vanadium represented by the formula VSₓ (wherein, x represents a positive real number) such as V₃S₄, VS₂, and VS, sulfides of iron represented by the formula FeSₓ (wherein, x represents a positive real number) such as Fe₃S₄, FeS₂, and FeS, sulfides of molybdenum represented by the formula MoSₓ (wherein, x represents a positive real number) such as Mo₂S₃, and MoS₂, sulfides of tin represented by the formula SnSₓ (wherein, x represents a positive real number) such as SnS₂, and SnS, sulfides of tungsten represented by the formula WSₓ (wherein, x represents a positive real number) such as WS₂, sulfides of antimony represented by the formula SbSₓ (wherein, x represents a positive real number) such as Sb₂S₃, sulfides of selenium represented by the formula SeSₓ (wherein, x represents a positive real number) such as Se₅S₃, SeS₂, and SeS; etc. Specifically mentioned as the above-described nitride are lithium-containing nitrides such as Li₃N, and Li₃₋ₓAₓN (wherein, A represents Ni and/or Co, and 0<x<3.). These carbonaceous materials, oxides, sulfides and nitrides may be used together, and may be either crystalline or amorphous. Further, these carbonaceous materials, oxides, sulfides and nitrides are, in most cases, supported on a negative electrode current collector, and used as an electrode.

The negative electrode is usually in the form of a sheet, and can be produced by allowing a negative electrode mixture containing a negative electrode active material such as the above-described carbonaceous materials to be supported on a negative electrode current collector in the form of a sheet. The above-described negative electrode mixture may contain a binder, if necessary. The binder includes thermoplastic resins, and specifically mentioned are PVDF, thermoplastic polyimide, carboxymethylcellulose, polyethylene, polypropylene and the like.

Examples of the above-described negative electrode current collector include Cu, Ni and stainless steel, and particularly in a lithium secondary battery, Cu is preferable from the perspectives that Cu does not easily form an alloy with lithium and is easily processed into a thin film. Examples of a method of supporting a mixture containing a negative electrode active material on the negative electrode current collector include a method of pressure-molding or a method of pasting by using solvent to fix firmly by applying, drying and thereafter pressing on the current collector.

Specifically mentioned as the above-described metal as the negative electrode active material are lithium metal, silicon metal and tin metal. The above-described alloys include lithium alloys such as Li—Al, Li—Ni, and Li—Si, silicon alloys such as Si—Zn, tin alloys such as Sn—Mn, Sn—Co, Sn—Ni, Sn—Cu, and Sn—La, and additionally, alloys such as Cu₂ Sb, and La₃ Ni₂Sn₇. These metals and alloys are, in most cases, used solely as an electrode (for example, used in the form of foil).

Next, the separator is explained. As the separator, a member that has a form of porous film, non-woven fabric, woven fabric and the like, and is made of a material including a polyolefin resin such as polyethylene, and polypropylene, a fluorine resin, a nitrogen-containing and aromatic polymer can be used. Two or more materials may be used to give the separator, and the members may be laminated. The separator is disclosed, for example, in JP-A Nos. 2000-30686 and 10-324758, and the like. It is preferable that the thickness of the separator be thinner as long as the mechanical strength can be kept, from the standpoint of increase in the volume energy density of the battery and decrease in the internal resistance thereof. The separator has a thickness of usually from about 5 to about 200 μm, preferably from about 5 to about 40 μm.

In the present invention, the separator preferably has a porous film containing a thermoplastic resin. In the nonaqueous electrolyte secondary battery, the separator is placed between a positive electrode and a negative electrode, and preferably plays a role by which, when an abnormal current flows in the battery because of short circuit between the positive electrode and the negative electrode, and the like, the current is interrupted to block (shutdown) the flow of excessive current. Here, shutdown is carried out by obstructing micropores of the porous film of the separator, in the case of surpassing usual use temperature. Even when the temperature in the battery increases to a certain high temperature after the shutdown, it is preferable that the separator maintain the shutdown state without being ruptured due to the temperature, in other words, have high heat resistance. This separator includes porous films having a heat resistance material such as a laminated film in which a heat resistant porous layer and a porous film are laminated. By using this porous film as the separator, the thermal film rupture of the secondary battery of the present invention can be prevented more efficiently. That is, it becomes possible to further increase the heat resistance of the secondary battery. The heat resistant porous layer may be laminated on both surfaces of the porous film.

In the separator in the present invention, it is preferable that the porous film have micropores, and have a shutdown function. In this case, the porous film contains a thermoplastic resin. The porous film has a thickness of usually 3 to 30 μm, more preferably 3 to 25 μm. The porous film has micropores, and its pore size is usually 3 μm or less, preferably 1 μm or less. The porous film has a porosity of usually 30 to 80 vol %, preferably 40 to 70 vol %. In the nonaqueous electrolyte secondary battery, in the case of surpassing the usual use temperature, the porous film is capable of obstructing micropores, by softening of the thermoplastic resin constituting the film.

As the above-described thermoplastic resin, those which are softened at 80 to 180° C. are mentioned, and those which are not dissolved in an electrolyte of a nonaqueous electrolyte secondary battery may be advantageously selected. Specifically mentioned are polyolefin resins such as polyethylene, and polypropylene, and thermoplastic polyurethane resins, and a mixture of two or more of these resins may also be used. For softening at lower temperature to attain shutdown, it is preferable that polyethylene be contained as the thermoplastic resin. As the polyethylene, specifically mentioned are polyethylenes such as low density polyethylene, high density polyethylene, and linear polyethylene, and ultrahight molecular weight polyethylenes having a molecular weight of 1000000 or more are also mentioned. For further enhancing the puncture strength of a porous film, it is preferable that the thermoplastic resin contain an ultrahight molecular weight polyethylene. From the standpoint of production of a porous film, it is preferable in some cases that the thermoplastic resin contain a wax composed of a polyolefin of low molecular weight (weight average molecular weight: 10000 or less).

The above-described laminated film is one in which a heat resistant porous layer is laminated on the above-described porous film. The separator composed of the laminated film is explained below. The separator has a thickness of usually 40 μm or less, preferably 20 μm or less. When the thickness of the heat resistant porous layer is represented by T_{A} (μM) and the thickness of the porous film is represented by T_{B} (μM), the value of T_{A}/T_{B} is preferably 0.1 or more and 1 or less. Further, this separator has an air permeability according to the Gurley method permeability of preferably 50 to 300 sec/100 cc, further preferably 50 to 200 sec/100 cc, from the standpoint of ion permeability. This separator has a porosity of usually 30 to 80 vol %, preferably 40 to 70 vol %. The separator may also be one in which porous films having differing porosities are laminated.

In the laminated film, the heat resistant porous layer is a layer having higher heat resistance than the porous film, and the heat resistant porous layer may be formed from an inorganic powder, or may contain a heat resistant resin. Since the heat resistant porous layer contains a heat resistant resin, the heat resistant porous layer can be formed by an easy method such as coating. For further enhancing ion permeability, it is preferable that the heat resistant porous layer have a thickness of 1 μm or more and 10 μm or less, further preferably 1 μm or more and 5 μm or less and particularly preferably 1 μm or more and 4 μm or less to be a thinner heat resistant porous layer. The heat resistant porous layer has micropores, and its pore size (diameter) is usually 3 μm or less, preferably 1 μm or less. Further, the heat resistant porous layer may also contain fillers described below.

The heat resistant resin contained in the heat resistant porous layer includes a polyamide, polyimide, polyamideimide, polycarbonate, polyacetal, polysulfone, polyphenylene sulfide, polyether ketone, aromatic polyester, polyether sulfone and polyether imide, and from the standpoint of further enhancing heat resistance, preferable are a polyamide, polyimide, polyamideimide, polyether sulfone and polyether imide, more preferable are a polyamide, polyimide and polyamideimide. Furthermore preferable are nitrogen-containing aromatic polymers such as an aromatic polyamide (para-oriented aromatic polyamide, meta-oriented aromatic polyamide), aromatic polyimide, and aromatic polyamideimide, and especially preferable is an aromatic polyamide, and from the standpoint of production, particularly preferable is a para-oriented aromatic polyamide (hereinafter, referred to as “para-aramide” in some cases). The heat resistant resin includes poly-4-methylpentene-1 and cyclic olefin polymers. By using these heat resistant resins, heat resistance can be enhanced, namely, the thermal film rupture temperature can be raised. In the case of use of a nitrogen-containing aromatic polymer among these heat resistant resins, compatibility with an electrolyte, namely, a liquid retaining property on the heat resistant porous layer also increases in some cases, and also the rate of impregnation of an electrolyte in production of a nonaqueous electrolyte secondary battery is high, and also the charge and discharge capacity of a nonaqueous electrolyte secondary battery increases further.

The thermal film rupture temperature depends on the kind of the heat resistant resin, and is selected according to the use stage and use object. Usually, the thermal film rupture temperature is 160° C. or more. The thermal film rupture temperature can be controlled to about 400° C. in the case of use of the above-described nitrogen-containing aromatic polymer, to about 250° C. in the case of use of poly-4-methylpentene-1 and to about 300° C. in the case of use of a cyclic olefin polymer, as the heat resistant resin, respectively. When the heat resistant porous layer is composed of an inorganic powder, it is also possible to control the thermal film rupture temperature to, for example, 500° C. or more.

The above-described para-aramide is obtained by condensation polymerization of a para-oriented aromatic diamine and a para-oriented aromatic dicarboxylic halide, and consists substantially of a repeating unit in which an amide bond is bonded at a para-position or equivalently oriented position of an aromatic ring (for example, the oriented position extending coaxially or in parallel to the opposite direction, such as 4,4′-biphenylene, 1,5-naphthalene, and 2,6-naphthalene). As the para-aramide, exemplified are para-aramides having a para-oriented-type structure or a quasi-para-oriented-type structure, specifically, poly(para-phenyleneterephthalamide), poly(para-benzamide), poly(4,4′-benzanilide terephthalamide), poly(para-phenylene-4,4′-biphenylene dicarboxylic amide), poly(para-phenylene-2,6-naphthalene dicarboxylic amide), poly(2-chloro-para-phenyleneterephthalamide), para-phenyleneterephthalamide/2,6-dichloro para-phenyleneterephthalamide copolymer, and the like.

As the above-described aromatic polyimide, preferable are wholly aromatic polyimides produced by polycondensation of an aromatic dianhydride and a diamine. Specific examples of the aromatic dianhydride include pyromellitic dianhydride, 3,3′,4,4′-diphenylsulfone tetracarboxylic dianhydride, 3,3′,4,4′-benzophenone tetracarboxylic dianhydride, 2,2′-bis(3,4-dicarboxyphenyl)hexafluoropropane, and 3,3′,4,4′-biphenyl tetracarboxylic dianhydride. The diamine includes oxydianiline, para-phenylenediamine, benzophenonediamine, 3,3′-methylenedianiline, 3,3′-diaminobenzophenone, 3,3′-diaminodiphenylsulfone, and 1,5′-naphthalenediamine. Further, solvent-soluble polyimides can be suitably used. As such a polyimide, for example, a polyimide as a polycondensate of 3,3′,4,4′-diphenylsulfone tetracarboxylic dianhydride and an aromatic diamine is mentioned.

The above-described aromatic polyamideimide includes those obtained by condensation-polymerizing an aromatic dicarboxylic acid and an aromatic diisocyanate, and those obtained by condensation-polymerizing an aromatic dianhydride and an aromatic diisocyanate. Specific examples of the aromatic dicarboxylic acid include isophthalic acid, and terephthalic acid. Specific examples of the aromatic dianhydride include trimellitic anhydride and the like. Specific examples of the aromatic diisocyanate include 4,4′-diphenylmethane diisocyanate, 2,4-tolylene diisocyanate, 2,6-tolylene diisocyanate, ortho-tolylene diisocyanate, and m-xylene diisocyanate.

When the heat resistant porous layer contains a heat resistant resin, the heat resistant porous layer may contain one or more kinds of a filler. The filler which may be contained in the heat resistant porous layer may be an organic powder, inorganic powder or a mixture thereof. It is preferable that particles constituting a filler have an average particle diameter of 0.01 μm or more and 1 μm or less. The shape of the filler includes an approximately spherical shape, a plate shape, a column shape, a needle shape, a whisker shape, a fiber shape and the like, and any particles of these shapes can be used. The filler is preferably approximately spherical particles since uniform pores are formed easily in the resultant heat resistant porous layer. The approximately spherical particles include particles having a particle aspect ratio (particle major axis/particle minor axis) in the range of 1 or more and 1.5 or less. The particle aspect ratio can be measured by an electron micrograph.

Examples of the organic powder as the filler include a powder made of an organic material such as a homopolymer of or copolymer of two or more kinds of styrene, vinyl ketone, acrylonitrile, methyl methacrylate, ethyl methacrylate, glycidyl methacrylate, glycidyl acrylate, and methyl acrylate; a fluorine-containing resin such as polytetrafluoroethylene, ethylene tetrafluoride-propylene hexafluoride copolymer, ethylene tetrafluoride-ethylene copolymer, and polyvinylidene fluoride; a melamine resin; an urea resin; a polyolefin; and a polymethacrylate. These organic powders may be used singly, or in admixture of two or more. Among these organic powders, a polytetrafluoroethylene powder is preferable from the standpoint of chemical stability.

Examples of the inorganic powder as the filler include powders made of an inorganic material such as metal oxide, metal nitride, metal carbide, metal hydroxide, carbonate, and sulfate. Among them, powders composed of an inorganic material having low electric conductivity are preferably used. Specifically mentioned are powders composed of alumina, silica, titanium dioxide, barium sulfate, calcium carbonate or the like. These inorganic powders may be used singly or in admixture of two or more. Among these inorganic powders, an alumina powder is preferable from the standpoint of chemical stability. It is more preferable that all of particles constituting the filler be alumina particles, and it is further more preferable that all of particles constituting the filler be alumina particles and a part of or all of them are approximately spherical alumina particles. When the heat resistant porous layer is formed from an inorganic powder, the above-exemplified inorganic powders may be advantageously used, and if necessary, a binder may be mixed with them.

When the heat resistant porous layer contains a heat resistant resin, the content of a filler depends on the specific gravity of the material of the filler. For example, in the case where all of particles constituting the filler are alumina particles, the weight of the filler is usually 5 or more and 95 or less, preferably 20 or more and 95 or less and more preferably 30 or more and 90 or less, assuming that the total weight of the heat resistant porous layer is 100. These ranges can be appropriately set, depending on the specific gravity of the material of the filler.

Further examples of the porous film containing a heat resistant material which is different from the above-described laminated film include porous films composed of a heat resistant resin and/or an inorganic powder, and porous film in which a heat resistant resin and/or an inorganic powder is dispersed in a thermoplastic resin film made of, e.g., a polyolefin resin and thermoplastic polyurethane resin. Here, as the heat resistant resin and the inorganic powder, those described above are mentioned.

Next, the nonaqueous electrolyte is explained. The nonaqueous electrolyte contains an electrolyte and an organic solvent. The electrolyte in the above-described nonaqueous electrolyte includes lithium salts such as LiClO₄, LiPF₆, LiAsF₆, LiSbF₆, LIBF₄, LiCF₃SO₃, LiN(SO₂CF₃)₂, LiN(SO₂C₂F₅)₂, LiN(SO₂CF₃) (COCF₃), Li(C₄F₉SO₃), LiC(SO₂CF₃)₃, Li₂B₁₀Cl₁₀, LiBOB (wherein, BOB means bis(oxalato) borate), lower aliphatic carboxylic acid lithium salts, and LiAlCl₄, when M¹ represents Li in the present invention. These electrolytes may be used singly. A mixture of two or more thereof may also be used. For enhancing the capacity of the resultant nonaqueous electrolyte secondary battery, it is preferable to use one or more fluorine compounds selected from the group consisting of LiPF₆, LiAsF₆, LiSbF₆, LiBF₄, LiCF₃SO₃, LiN(SO₂CF₃)₂ and LiC(SO₂CF₃)₃, as the lithium salt. When M¹ represents Na, sodium salts obtained by substituting Li in the above-described lithium salts by Na may be used as the electrolyte.

In the above-described nonaqueous electrolyte, examples of the organic solvent which can be used include, carbonates such as propylene carbonate (PC), ethylene carbonate (EC), dimethyl carbonate (DMC), diethyl carbonate (DEC), ethyl methyl carbonate (EMC), 4-trifluoromethyl-1,3-dioxolan-2-one, and 1,2-di(methoxycarbonyloxy)ethane; ethers such as 1,2-dimethoxyethane, 1,3-dimethoxypropane, pentafluoropropyl methyl ether, 2,2,3,3-tetrafluoropropyl difluoromethyl ether, tetrahydrofuran, and 2-methyltetrahydrofuran; esters such as methyl formate, methyl acetate, and γ-butyrolactone; nitriles such as acetonitrile, and butyronitrile; amides such as N,N-dimethylformamide, and N,N-dimethylacetamide; carbamates such as 3-methyl-2-oxazolidone; sulfur-containing compounds such as sulfolane, dimethyl sulfoxide, and 1,3-propane sultone, and those obtained by introducing fluorine substituent thereto may be used. Usually, two or more of these solvents are used in admixture. Among the above-described organic solvents, preferable are organic solvents containing a carbonate. As the carbonate, cyclic carbonates are mentioned in addition to non-cyclic carbonates. It is preferable to use a mixed solvent containing ethylene carbonate, dimethyl carbonate and ethyl methyl carbonate, among carbonates, in view of poor degradability.

In the nonaqueous electrolyte of the present invention, it is preferable to use the above-described fluorine compound as the electrolyte, and to use the above-described carbonate as the organic solvent. By using the nonaqueous electrolyte containing the carbonate and the fluorine compound, in the present invention, as described above, it becomes possible to further enhance the capacity of the secondary battery of the present invention. As the nonaqueous electrolyte containing the carbonate and the fluorine compound, a carbonate containing a fluorine atom introduced as a substituent may also be used.

Using the positive electrode, the separator, the negative electrode and the nonaqueous electrolyte described above, a nonaqueous electrolyte secondary battery can be produced as described below. That is, the positive electrode, separator and negative electrode are laminated in this order, and in necessary subjected to winding, to obtain an electrode group which is then accommodated in an exterior body such as a battery can and a laminate film, and the electrolyte is impregnated in the armoring body, thus, a nonaqueous electrolyte secondary battery can be produced.

Examples of a shape of the above-described electrode group include a shape that gives a circular shape, an elliptical shape, a long circular shape, a rectangular shape, a rounded rectangular shape and the like of the cross section when the electrode group is cut in a direction perpendicular to the axis of winding thereof. Examples of the shape of the battery include a paper shape, a coin shape, a cylinder shape, and an angular shape.

Next, the present invention is illustrated further in detail by examples. Production and evaluation of each member constituting a battery in examples and comparative examples were carried out as described below.

### (1) Measurement of BET Specific Surface Area (S) of Positive Electrode Active Material

The BET specific surface area was measured by the BET one point method using a BET specific surface area measurement apparatus (Flow Sorb II 2300, manufactured by Micromeritics).

### (2) Bulk Composition Analysis of Positive Electrode Active Material

Using an aqueous electrolyte obtained by dissolving a positive electrode active material in hydrochloric acid, the bulk composition ratio was measured with ICP-AES (manufactured by SEIKO Electronics Industrial Co., Ltd.).

### (3) Surface Composition Analysis of Positive Electrode Active Material

The surface composition of a positive electrode active material was analyzed by the following method.

Method: X-ray photoelectron spectroscopy (XPS)

X-ray: AlKα-ray (1486.6 eV)

X-ray spot diameter: 100 μm

Neutralization condition: neutralization electron gun (1 eV electron beam), low speed Ar ion gun (10 eV Ar ion beam)

Narrow scan spectra of elements on the surface of a positive electrode active material were measured, and from the photoelectron intensity ratio thereof, A on the surface of the positive electrode active material was calculated. As the photoelectron intensity of Al, the integral value of the waveform of Al2p was used, as the photoelectron intensity of B, the integral value of the waveform of B1s was used, as the photoelectron intensity of Ga, the integral value of the waveform of Ga2p3/2 was used, as the photoelectron intensity of In, the integral value of the waveform of In3d5/2 was used, as the photoelectron intensity of Ni, the integral value of the waveform of Ni2p3/2 was used, as the photoelectron intensity of Co, the integral value of the waveform of Co2p3/2 was used, as the photoelectron intensity of Mn, the integral value of the waveform of Mn2p3/2 was used and as the photoelectron intensity of Fe, the integral value of the waveform of Fe2p3/2 was used, respectively, and based on these values, A as the molar ratio (M³/M²) of the number of M³ atoms (mol) to the number of M² atoms (mol) on the surface was calculated.

### (4) Production of Positive Electrode

To a mixture of a positive electrode active material and an electric conductive material (mixture of acetylene black and graphite of 1:9) was added an NMP solution of PVDF as a binder so as to give a composition of positive electrode active material:electric conductive material:binder=87:10:3 (weight ratio) and the mixture was kneaded to obtain a paste, and the paste was coated on an Al foil having a thickness of 20 μm as a current collector, and this was dried at 60° C. for 1 hour, the resultant sheet was pressed and dried in vacuo at 150° C. for 8 hours, to produce a positive electrode.

### (5) Production of Negative Electrode

To artificial graphite as a negative electrode active material was added a solution prepared by dissolving carboxymethylcellulose (CMC) as a binder in water so as to give a composition of positive electrode active material:binder=98:2 (weight ratio) and the mixture was kneaded to obtain a paste, and the paste was coated on a Cu foil having a thickness of 12 μm as a current collector, and this was dried at 90° C. for 5 minutes, then, dried in vacuo at 60° C. for 12 hours, the resultant sheet was pressed and further dried in vacuo at 120° C. for 5 hours, to produce a negative electrode.

### (6) Production of Nonaqueous Electrolyte

LiPF₆ was used as an electrolyte, and this electrolyte was dissolved in an organic solvent composed of ethylene carbonate (EC), dimethyl carbonate (DMC) and ethyl methyl carbonate (EMC) mixed as a volume ratio of 15:10:75 (=EC:DMC:EMC), so as to give a concentration of LiPF₆ of 1 mol/liter, to produce a nonaqueous electrolyte.

### (7) Production of Separator (Laminated Film)

Calcium chloride (272.7 g) was dissolved in NMP (4200 g), then, para-phenylenediamine (132.9 g) was added and dissolved completely. To the resultant solution was added gradually 243.3 g of terephthalic dichloride and polymerization thereof was carried out to obtain a para-aramide, and this was diluted further with NMP, to obtain a para-aramide solution having a concentration of 2.0% by weight. To 100 g of the resultant para-aramide solution was added 2 g of an alumina powder (a) (manufactured by Nippon Aerosil Co., Ltd., Alumina C, average particle diameter of 0.02 μm) and 2 g of an alumina powder (b) (Sumicorandom manufactured by Sumitomo Chemical Co., Ltd., AA03, average particle diameter of 0.3 μm) as a filler in a total amount of 4 g, and these were mixed and treated three times by a nanomizer, and further, filtrated through a 1000 mesh wire netting, and de-foamed under reduced pressure to produce a slurry for coating. The weight of the alumina powders (filler) with respect to the total weight of the para-aramide and the alumina powders was 67% by weight.

A polyethylene porous film (thickness of 12 μm, air permeability of 140 sec/100 cc, average pore size of 0.1 μm, porosity of 50%) was used as a porous film. On a PET film having a thickness of 100 μm, the above-described polyethylene porous film was fixed, and the above-described slurry for coating was coated on the porous film by a bar coater manufactured by Tester Sangyo Co., Ltd. The coated porous film on the PET film was, while maintaining the integrity, immersed in water which is a poor solvent, to precipitate a para-aramide layer (heat resistant porous layer), then, the solvent was dried and the PET film was peeled, to obtain a laminated film in which the heat resistance porous layer and the porous film were laminated. The thickness of the laminated film was 16 μm, and the thickness of the heat resistant porous layer was 4 μm. The laminated film had an air permeability of 180 sec/100 cc, and a porosity of 50%. The cross section of the heat resistant porous layer in the laminated film was observed by a scanning electron microscope (SEM) to find that relatively small micropores of about 0.03 μm to 0.06 μm and relatively large micropores of about 0.1 μm to 1 μm were present. Evaluation of the laminated film was carried out by the following methods (i) to (iii).

### (i) Measurement of Thickness

The thickness of the laminated film and the thickness of the shutdown layer were measured according to JIS standard (K7130-1992). As the thickness of the heat resistant porous layer, a value obtained by subtracting the thickness of the shutdown layer from the thickness of the laminated film was used.

### (ii) Measurement of Air Permeability by Curley Method

The air permeability of the laminated film was measured by digital timer mode Gurley type Densometer manufactured by Yasuda Seiki Seisakusho Ltd., according to JIS P8117.

(iii) Porosity

A sample of the resultant laminated film was cut into a square having a side length of 10 cm, and the weight W (g) and the thickness D (cm) thereof were measured. The weights (Wi (g)) of the layers in the sample were measured, and the volumes of the respective layers were calculated from Wi and the true specific gravities (true specific gravity i (g/cm)) of the materials of the respective layers, and the porosity (vol %) was calculated according to the following formula.

Porosity(vol %)=100×{1−(W1/true specific gravity 1+W2/true specific gravity 2+··+Wn/true specific gravity n)/(10×10×D)}

### (8) Measurement of Capacity of Positive Electrode

A coin cell (manufactured by Hohsen Corp.) was used, and the positive electrode obtained in the above-described section (4), a polypropylene porous film (thickness: 20 μm) as a separator, and metal lithium as a negative electrode were used and laminated in this order, and a nonaqueous electrolyte was injected, to fabricate a coin shaped battery (R2032). As the nonaqueous electrolyte, a nonaqueous electrolyte obtained by dissolving an electrolyte LiPF₆ in an organic solvent composed of EC, DMC and EMC mixed at a volume ratio of 30:35:35 (=EC:DMC:EMC) so as to give a concentration of LiPF₆ of 1 mol/liter was used.

Using this coin shaped battery, a charge and discharge testing (25° C.) was carried out under the following conditions, to confirm the capacities of the positive electrode (charge capacity, discharge capacity).

Charge condition: charge maximum voltage 4.3 V, charge time 8 hours, charge current 0.6 mA/cm²

Discharge condition: discharge minimum voltage 3.0 V, discharge current 0.6 mA/cm²

### (9) Evaluation I of Nonaqueous Electrolyte Secondary Battery

A nonaqueous electrolyte secondary battery was charged under 4.2 V, and this was kept at 60° C. The volume of the battery after keeping for given time was measured, and the increase ratio of the battery volume was calculated according to the following formula.

Battery volume increase ratio=(battery volume after keeping at 60° C./battery volume before charge)

### (10) Evaluation II of Nonaqueous Electrolyte Secondary Battery

A nonaqueous electrolyte secondary battery was charged under 4.5 V, then, this was set in a box. The set battery was subjected to a nail penetration testing by allowing a cylindrical nail having a diameter of 2.8 mm to penetrate at a speed of 1 mm/sec by a remote operation while monitoring its appearance, voltage and surface temperature.

### Example 1

### Production of Core Material in Positive Electrode Active Material

Lithium hydroxide (LiOH.H₂O: manufactured by The Honjo Chemical Corporation, pulverized average particle diameter of 10 to 25 μm), nickel hydroxide (Ni(OH)₂: manufactured by Kansai Catalyst Co. Ltd., product name: nickel hydroxide No. 3) and cobalt oxide (CO₃O₄: manufactured by Seido Chemical Industry Co., Ltd., product name: Cobalt Oxide (HCO)) were weighed so that the molar ratio of Li:Ni:Co was 1.05:0.85:0.15, and mixed thereof using Loedige mixer (Manufactured by MATSUBO Corporation, type FM-130D) and the resultant powder was dried at 120° C. for 10 hours, then, pulverized and mixed under the following conditions using Dynamic Mill (manufactured by Mitsui Mining Co., Ltd., type MYD-5×A), to obtain a metal compound mixture powder 1.

Pulverization media: 6.1 kg of 5 mmφ high alumina

Revolution of agitator shaft: 650 rpm

Powder feeding amount: 12.0 kg/h

The metal compound mixture powder was filled in an alumina sheath, and calcined in an oxygen flow at 730° C. for 15 hours to obtain a block object. This block object was pulverized by a dry mode ball mill using 15 mmφ nylon-coated steel spheres as a pulverization medium, and pulverized until the volume-based average particle diameter reached 9 μm (average particle diameter was measured by laser scattering type particle size distribution measurement apparatus, Mastersizer MS2000 manufactured by Malvern Instruments Ltd.), to obtain a granular core material C1 (lithium mixed metal oxide). The BET specific surface area of this core material C1 was measured to find a value of 0.9 m²/g.

### (Production of Positive Electrode Active Material)

The obtained core material C1 of 30 kg and aluminum oxide of 1.25 kg (manufactured by Nippon Aerosil Co., Ltd., product name of “Alumina C”, primary particle diameter of 13 nm, BET specific surface area of 113 m²/g which is 126 times higher than that of the core material C1: when the content of Ni and Co in the core material C1 is 1 mol, the content of Al is 0.08 mol) were mixed by Loedige mixer (Manufactured by MATSUBO Corporation, type FM-130D) to obtain a powder which was then thermally treated in an oxygen flow at 725° C. for 1.2 hours to obtain a powder, and this powder was subjected to classification with an air classifier (Turboprex, manufactured by Hosokawa Micron Corporation, ATP-50) to reduce finer particle side, thereby obtaining a granular positive electrode active material 1.

The positive electrode active material 1 had a BET specific surface area S of 0.6 m²/g, and A as the molar ratio (M³/M²) of the number of Al atoms (mol) to the number of Ni and Co atoms (mol) on the surface was measured to find a value of 0.8, indicating that A/S was 1.3. In XPS in measuring A, there was no detection of Mn and Fe. According to the bulk composition analysis of the positive electrode active material 1, the molar ratio of Li:Ni:Co:Al was 0.97:0.82:0.13:0.05. Using the positive electrode active material 1, the capacities of the positive electrode were measured according to the above-described method (8) to find that the charge capacity was 222 mAh/g and the discharge capacity was 185 mAh/g, revealing high capacities.

### (Production of Nonaqueous Electrolyte Secondary Battery)

Using the positive electrode active material 1, a positive electrode was produced according to the above-described method (4). This positive electrode, a separator (laminated film) according to the above-described method (7) and a negative electrode according to the above-described method (5) were used and laminated in this order and wound to obtain an electrode group which was then accommodated in an exterior body made of an aluminum laminate film having a thickness of 4 mm, and the nonaqueous electrolyte according to the above-described method (6) was poured into the exterior body by vacuum impregnation, to produce a laminate type nonaqueous electrolyte secondary battery 1.

For the nonaqueous electrolyte secondary battery 1, the battery volume increase ratio was calculated according to the above-described evaluation I of nonaqueous electrolyte secondary battery to find that, after keeping for 6 hours, it was 1.05; and after keeping for 11 hours, it was 1.05; meaning extremely low battery volume increase ratio and suppression of change by time.

For the nonaqueous electrolyte secondary battery 1, a nail penetration testing was carried out according to the above-described evaluation II of nonaqueous electrolyte secondary battery, and no destruction of the battery was visually confirmed. Further, the penetrated nail was removed, the battery was disassembled to take out the separator, and the size of the hole generated on the separator was measured by optical microscope observation, to find that it was the same as the diameter of the nail.

### Example 2

### Production of Core Material in Positive Electrode Active Material

Lithium hydroxide (LiOH.H₂O: manufactured by The Honjo Chemical Corporation, pulverized average particle diameter of 10 to 25 μm) and nickel cobalt mixed hydroxide (Ni_{0.85}Co_{0.15}(OH)₂: average particle diameter of 9 μm, BET specific surface area of 24 m²/g) were weighed so that the molar ratio of Li:Ni:Co was 1.03:0.85:0.15 and mixed thereof using Loedige mixer (manufactured by MATSUBO Corporation, type FM-130D) to obtain a metal compound mixture powder 2.

Next, the mixture powder 2 was filled in an alumina sheath, and calcined in an oxygen flow at 750° C. for 10 hours, to obtain a granular core material C2 (lithium mixed metal oxide).

### (Production of Positive Electrode Active Material)

The resultant core material C2 of 30 kg and aluminum oxide (manufactured by Nippon Aerosil Co., Ltd., product name of “Alumina C”) were mixed by Loedige mixer (Manufactured by MATSUBO Corporation, type FM-130D), so that the content of Al was 0.06 mol with respect to 1 mol of the total amount of Ni and Co in the core material C2, to obtain a powder which was then thermally treated in an oxygen flow at 750° C. for 1.2 hours to obtain a powder, and this powder was subjected to classification with an air classifier (Turboprex, manufactured by Hosokawa Micron Corporation, ATP-50) to reduce finer particle side, thereby obtaining a granular positive electrode active material 2.

The positive electrode active material 2 had a BET specific surface area S of 0.35 m²/g, and A as the molar ratio (M³/M²) of the number of Al atoms (mol) to the numbers of Ni and Co atoms (mol) on the surface was measured to find a value of 1.2, indicating that A/S was 3.3. In XPS in measuring A, there was no detection of Mn and Fe. Using the positive electrode active material 2, the capacities of the positive electrode were measured according to the above-described method (8) to find that the charge capacity was 218 mAh/g and the discharge capacity was 186 mAh/g, revealing high capacities.

### (Production of Nonaqueous Electrolyte Secondary Battery)

A nonaqueous electrolyte secondary battery 2 was produced in the same manner as in Example 1 excepting that the positive electrode active material 2 was used instead of the positive electrode active material 1.

For the nonaqueous electrolyte secondary battery 2, the battery volume increase ratio was calculated according to the above-described evaluation I of nonaqueous electrolyte secondary battery to find that, after keeping for 6 hours, it was 1.03; and after keeping for 11 hours, it was 1.01; meaning extremely low battery volume increase ratio and suppression of change by time.

For the nonaqueous electrolyte secondary battery 2, a nail penetration testing was carried out according to the above-described evaluation II of nonaqueous electrolyte secondary battery, and no destruction of the battery was visually confirmed. Further, the penetrated nail was removed, the battery was disassembled to take out the separator, and the size of the hole generated on the separator was measured by optical microscope observation, to find that it was the same as the diameter of the nail.

### Example 3

### Production of Core Material in Positive Electrode Active Material

Lithium hydroxide (LiOH.H₂O: manufactured by The Honjo Chemical Corporation, pulverized average particle diameter of 10 to 25 μm) and nickel cobalt mixed hydroxide (Ni_{0.85}CO_{0.15}(OH)₂: average particle diameter of 11 μm, BET specific surface area of 22 m²/g) were weighed so that the molar ratio of Li:Ni:Co was 1.03:0.85:0.15 and mixed thereof using Loedige mixer (manufactured by MATSUBO Corporation, type FM-130D) to obtain a metal compound mixture powder 3.

Next, the mixture powder 3 was filled in an alumina sheath, and calcined in an oxygen flow at 750° C. for 10 hours, to obtain a granular core material C3 (lithium mixed metal oxide).

### (Production of Positive Electrode Active Material)

The resultant core material C3 of 30 kg and aluminum oxide (manufactured by Nippon Aerosil Co., Ltd., product name of “Alumina C”) were mixed by Loedige mixer (Manufactured by MATSUBO Corporation, type FM-130D), so that the content of Al was 0.06 mol with respect to 1 mol of the total amount of Ni and Co in the core material C3, to obtain a powder which was then thermally treated in an oxygen flow at 750° C. for 1.2 hours to obtain a powder, and this powder was subjected to classification using an air classifier (Turboprex, manufactured by Hosokawa Micron Corporation, ATP-50) to reduce finer particle side, thereby obtaining a granular positive electrode active material 3.

The positive electrode active material 3 had a BET specific surface area S of 0.30 m²/g, and A as the molar ratio (M³/M²) of the number of Al atoms (mol) to the number of Ni and Co atoms (mol) on the surface was measured to find a value of 1.8, indicating that A/S was 6. In XPS in measuring A, there was no detection of Mn and Fe. Using the positive electrode active material 3, the capacities of the positive electrode were measured according to the above-described method (8) to find that the charge capacity was 220 mAh/g and the discharge capacity was 186 mAh/g, revealing high capacities.

### (Production of Nonaqueous Electrolyte Secondary Battery)

A nonaqueous electrolyte secondary battery 3 was produced in the same manner as in Example 1 excepting that the positive electrode active material 3 was used instead of the positive electrode active material 1.

For the nonaqueous electrolyte secondary battery 3, the above-described evaluation I of nonaqueous electrolyte secondary battery was carried out, to obtain the same result as in Example 2. Further, for the nonaqueous electrolyte secondary battery 3, the above-described evaluation II of nonaqueous electrolyte secondary battery was carried out, to obtain the same result as in Example 2.

### Comparative Example 1

### Production of Core Material in Positive Electrode Active Material

Lithium hydroxide (LiOH.H₂O: manufactured by The Honjo Chemical Corporation, pulverized average particle diameter of 10 to 25 μm) and nickel cobalt hydroxide ((Ni_{0.85}Co_{0.15}(OH)₂, average particle diameter of 10 μm) were weighed so that the molar ratio of Li:Ni:Co was 1.05:0.85:0.15, and mixed thereof using Loedige mixer (Manufactured by MATSUBO Corporation, type FM-130D) and the resultant powder was dried at 120° C. for 10 hours, then, pulverized and mixed under the following conditions using Dynamic Mill (manufactured by Mitsui Mining Co., Ltd., type MYD-5×A), to obtain a metal compound mixture powder 4.

Pulverization media: 5 mmφ high alumina (6.1 kg)

Revolution of agitator shaft: 500 rpm

Powder feeding amount: 7 kg/h

The metal compound mixture powder 4 was filled in an alumina sheath, and calcined in an oxygen flow at 730° C. for 10 hours to obtain a block object. This block object was pulverized by a dry mode ball mill using 15 mmφ nylon-coated steel spheres as a pulverization medium, and pulverized until the volume-based average particle diameter reached 7 μm (average particle diameter was measured by laser scattering type particle size distribution measurement apparatus, Mastersizer MS2000 manufactured by Malvern Instruments Ltd.), to obtain a core material C4. The BET specific surface area of this core material C4 was measured to find a value of 0.6 m²/g.

### (Production of Positive Electrode Active Material)

The resultant core material C4 of 30 kg and aluminum oxide of 0.31 kg (manufactured by Nippon Aerosil Co., Ltd., product name of “Alumina C”, primary particle diameter of 13 nm, BET specific surface area of 113 m²/g which is 161 times higher than that of the core material C4: when the content of Ni and Co in the core material C4 is 1 mol, the content of Al is 0.02 mol) were mixed by Loedige mixer (Manufactured by MATSUBO Corporation, type FM-130D) to obtain a powder which was then thermally treated in an oxygen flow at 725° C. for 1.2 hours to obtain a powder, and this powder was subjected to classification with an air classifier (Turboprex, manufactured by Hosokawa Micron Corporation, ATP-50) to reduce finer particle side, thereby obtaining a granular positive electrode active material 4.

The positive electrode active material 4 had a BET specific surface area S of 0.5 m²/g, and A as the molar ratio (M³/M²) of the number of Al atoms (mol) to the number of Ni and Co atoms (mol) on the surface was measured to find a value of 0.2, indicating that A/S was 0.4. In XPS in measuring A, there was no detection of Mn and Fe. According to the bulk composition analysis of the positive electrode active material 4, the molar ratio of Li:Ni:Co:Al was 1.00:0.84:0.15:0.02. Using the positive electrode active material 4, the capacities of the positive electrode were measure according to the above-described method (8) to find that the charge capacity was 221 mAh/g and the discharge capacity was 173 mAh/g, revealing high capacities.

### (Production of Nonaqueous Electrolyte Secondary Battery)

A nonaqueous electrolyte secondary battery 4 was produced in the same manner as in Example 1 excepting that the positive electrode active material 4 was used instead of the positive electrode active material 1.

For the nonaqueous electrolyte secondary battery 4, the battery volume increase ratio was calculated according to the above-described evaluation I of nonaqueous electrolyte secondary battery to find that, after keeping for 6 hours, it was 1.12; and after keeping for 11 hours, it was 1.18; that is, the battery volume increase ratio was larger than those of the nonaqueous electrolyte secondary batteries in Examples.

For the nonaqueous electrolyte secondary battery 4, a nail penetration testing was carried out according to the above-described evaluation II of nonaqueous electrolyte secondary battery, and no destruction of the battery was visually confirmed. Further, the penetrated nail was removed, the battery was disassembled to take out the separator, and the size of the hole generated on the separator was measured by an optical microscope, to find that the diameter of the hole was 3.2 mm, confirming that it was slightly larger than the diameter of the nail.

### INDUSTRIAL APPLICABILITY

According to the present invention, a nonaqueous electrolyte secondary battery having higher safety can be provided. According to the nonaqueous electrolyte secondary battery of the present invention, its swelling can be reliably suppressed, particularly, even if it is kept at high temperature. Further, the nonaqueous electrolyte secondary battery of the present invention is industrially extremely useful because of high capacity and high power output.

1. A nonaqueous electrolyte secondary battery comprising
a positive electrode containing a granular positive electrode active material composed of a mixed metal oxide and an De-containing compound (M³ represents one or more elements selected from the group consisting of Group 3B elements in the periodic table, and the De-containing compound is different from said mixed metal oxide) placed in the form of particles or a layer on the surface of the mixed metal oxide, wherein the positive electrode active material has M¹ (M¹ represents one or more elements selected from the group consisting of alkali metal elements), M² (M² represents one or more elements selected from the group consisting of Mn, Fe, Co and Ni), M³ (M³ has the same meaning as that described above) and O on its surface, and when the molar ratio (M³/M²) of the number of M³ atoms (mol) to the number of M² atoms (mol) on the surface of the positive electrode active material is represented by A and the BET specific surface area of the positive electrode active material is represented by S (m²/g), A and S satisfy the following formula (I):
A/S≧1 (1),
a negative electrode,
a separator, and
a nonaqueous electrolyte.

2. The nonaqueous electrolyte secondary battery according to claim 1, wherein the separator is composed of a laminated film in which a heat resistant porous layer and a porous film are laminated.

3. The nonaqueous electrolyte secondary battery according to claim 1, wherein the nonaqueous electrolyte contains a carbonate and a fluorine compound.

4. The nonaqueous electrolyte secondary battery according to claim 1, wherein the negative electrode contains a carbonaceous material as a negative electrode active material.

5. The nonaqueous electrolyte secondary battery according to claim 1, wherein said A is 0.35 or more.

6. The nonaqueous electrolyte secondary battery according to claim 1, wherein said S is 0.1 or more and 3 or less.

7. The nonaqueous electrolyte secondary battery according to claim 1, wherein said M¹ represents Li.

8. The nonaqueous electrolyte secondary battery according to claim 1, wherein said M³ represents Al.

9. The nonaqueous electrolyte secondary battery according to claim 1, wherein said M² represents Ni and Co.
